(19) United States
(12) Patent Application Publication
(10) Pub. No.: US 2010/0116150 A1
(43) Pub. Date: May 13, 2010

(54) CONTROLLED DYNAMIC RADIANT FRYING OVEN

(75) Inventors: Ted J. Fiock, Warren, IN (US); Gene F. Della Valle, Indianapolis, IN (US); William L. Hazelbaker, Middletown, IN (US); Robert J. Metz, Anderson, IN (US)

Correspondence Address: INNOVATION LAW OFFICE OF DENNIS SCHELL, 133 WEST MARKET STREET # 256, INDIANAPOLIS, IN, 46204, US

(73) Assignee: ANDERSON TOOL AND ENGINEERING CO INC, Anderson, IN (US)

(21) Appl. No.: 12/616,140

(22) Filed: Nov. 10, 2009

Related U.S. Application Data
(60) Provisional application No. 61/112,780, filed on Nov. 10, 2008.

(51) Int. Cl. A21B 1/22; A21B 1/42

(52) U.S. Cl. 99/443 C; 99/448; 219/388; 219/411; 126/19 R

(57) ABSTRACT

A controlled dynamic radiant (CDR) oven uses a dynamic heating method to reproduce food material changes that occur during the frying process without immersing the food in oil. The CDR oven includes a conveyance system for moving food along a radiant frying path having various heating zones. The conveyance system includes individual food portion carriers. Radiant emitters, for example IR emitters, are located behind a spatter screen in each heating zone and to each side of the radiant frying path. Different heating zones utilize different radiant emissions to achieve various heat fluxes and heat profiles, for example, mimicking that of an oil immersion frying heat profile. The radiant frying path can be optionally oriented along a substantially vertical axis to minimize the oven footprint. The CDR oven also can be combined with refrigeration/freezer unit and a payment and dispensing system for vending of food product.

### CROSS-REFERENCE TO RELATED APPLICATIONS

This application is a continuation of and claims the benefit of U.S. Provisional Patent Application No. 61/112,780, filed Nov. 10, 2008, and titled Controlled Dynamic Radiant Frying Oven, which is incorporated herein by reference.

### BACKGROUND

The present invention relates to food processing equipment, and in particular, to an oven system for controlled dynamic radiant frying.

Americans enjoy fried foods. It is estimated that the fried foods industry is a $75 Billion industry in the United States with a value at least double that for the rest or the world. Fried foods include a host of products, such as potato chips, donuts, chicken nuggets, and breaded seafood. The most popular fried food is French fries with over 8 billion pounds consumed annually in the United States. Exports of par-fried (partially) fried French fries totals over 1 billion pounds and growing. As billions or pounds of fried foods are produced and consumed each year in the United State alone, oil content in fried foods must be considered to significantly impact consumer health through obesity and obesity related health problems such as heart disease and high cholesterol. Healthy food choices exist for Americans, but most times at a cost and flavor disadvantage. This disclosure describes an alternative frying process system that would allow Americans to have healthier fried food choices by lowering fat and caloric content and still meeting consumer's cost and flavor requirements. The system comprises a Controlled Dynamic Radiant (CDR) Oven System.

The majority of French fries are served in quick serve restaurants (QSR) as a side item. Processors and producers of fried foods benefit from a high throughput and sales of a safe, value-added product. Consumers enjoy fried products such as French fries because of convenience, low cost, and appealing taste. Sensory properties include a golden color, crunchy crust, moist core, and a pleasing flavor.

While the process and product are popular, there are several key disadvantages of frying and fried foods. Product disadvantages are principally associated with oil quality and oil content of the final product. The foremost concern is the high caloric content of fried foods, primarily derived from the high oil content. By weight, chips may contain over 40% oil, doughnuts 20%, and French fries 15-20%. A large order of French fries contains, on average, approximately 540 calories and 26 g of fat. The FDA recommended daily intake (RDI) based on a 2,000-calorie diet is 65 g of fat, thus one large order of French flies approaches 45% of the RDI for fat.

Studies have shown remarkable ability in producing par-fried foods using controlled dynamic radiant (CDR) technology. CDR technology, where thermal radiant emitters are controlled in a variable combination of operational settings, can establish a heating system with variable levels of heat flux, surface temperatures, and wavelength distributions. In simple terms, such technology can provide a heating environment of variable adjustment and use, allowing operational settings that can heat the inside of a frozen product, the outside of the frozen product, or any particular combination of varied applied heat and temperature throughout the entire product size and shape. Although this CDR process is available, it has not been linked to commercially available equipment.

One of the biggest challenges with the frying industry is the control of oil uptake and oil movement within a fried product. The use of various product coatings have led to decreases in oil uptake, but the process still suffers from a lack of control of this variable. Other disadvantages of immersion frying pertain to the use of finish fryers in QSRs. Frying oil degradation reduces oil and product quality as the oil ages and changes in chemical composition. Other disadvantages include initial oil cost, variable oil quality, cost of waste oil disposal, need for use of caustic cleaning agents, and the large number of burn accidents associated with immersion fryers that occur each year.

The majority of fryers in QSRs are used for finish frying of par-fried foods such as French fries, chicken strips, and seafood. An estimated 750,000 fryers are used in QSRs nationwide. This figure does not include institutions and wholesale manufacturers. Development of an alternative finish frying process would be of great economic importance to the snack food, food service, and fast food industries. The ideal process would produce the desirable characteristics of fried products, allow controlled oil content of the finished product, and replace the deep fat fryer in the QSR and other food service establishments, thereby eliminating or reducing the use of hot oil and hazards associated with its use.

The CDR process mimics the heat transfer during immersion frying. Immersion frying does not constitute a constant rate heal transfer but rather a dynamic heating process with initial rates on the order of 30,000 W/m². Alternative methods to mimic immersion frying developed thus far have used convection air heat transfer end/or constant flux radiant heating. Each process has had some success; however, limitations exist. Convection heating cannot deliver the intense heat flux required for crust development without using high air velocities that dries the product and strips oil out. Radiant heat transfer applied only at constant rates result in a charred surface with an under-heated core unless a microwave radiation is applied first. Devices relying on a constant heat flux from an emission source to maintain a set point temperature environment produce food reported to be tougher, have a drier mouth feel, and have little resemblance to their traditionally fried counterpart. The fundamental aspects of frying a product without oil have largely been neglected.

Reproduction of the dynamic heat transfer rates found in immersion frying can be accomplishment by electromagnetic energy in the visible, near, and far infrared wavelengths from approximately 0.4 to 1000 μm. Radiant heat sources (emitters) are capable of generating over 100,000 W/m² with precise control of the output. The incident heat flux intensity and spectral distribution affect the ratio and intensity of short and long wavelength radiation and thus the product heating rates and heating profiles (heat flux versus time). CDR technology provides this level of heating rates and profiles to reproduce immersion-frying characteristics without oil.

Laboratory evaluation of CDR technology with French fries found that the finished CDR prepared products were equally acceptable to those prepared by immersion frying. These evaluations determined that overall appearance, acceptability, flavor, and mouth feel were equal between the preparation methods

The benefits are potentially great in that this technology can bring lower fat and lower caloric food types assisting our general public with efforts to control obesity and obesity related health issues. Side benefits include similar investment cost by current immersion fryer users, lower energy usage, and safer system for users and operators of the technology.

The CDR technology has the potential for use in many types of food products, including formed food product types, for example, products such as chicken nuggets, chicken strips, fish fillets, hamburger products, and doughnuts; However, improvements over earlier CDR ovens are required for test kitchen CDR ovens used to test radiant frying on existing and newly developed food products, and in order to provide CDR ovens suitable for other environments, including food manufacturing facilities, QSRs, industrial kitchens, convenience stores, food vending, residential kitchens, and other environments.

For example, an earlier CDR oven provided a transport belt that lacked control of spacing of food products, had uneven heating due to convection differences from emitters located above and below the food product, and that had lower emitters exposed to dripping oil and other falling debris and had upper emitters exposed to excess heat from convection. Additionally, the earlier CDR oven lacked a control system capable of automating heating profile selection for various types of food products.

### SUMMARY

The present invention may comprise one or more of the features recited in the attached claims, and/or one or more of the following features and combinations thereof.

An illustrative embodiment of a CDR oven according to the present disclosure uses a complex, dynamic heating method to reproduce material changes that occur during the frying process without immersing the food in oil. Specifically, the oven uses electronically and/or mechanically controlled radiant emitters to reproduce the heat flux observed during the immersion frying process, for example, the methods disclosed by U.S. Pat. No. 7,307,243, Dynamic Radiant Food Preparation Methods and System, issued on Dec. 11, 2007 to Brian Farkas, Brian Lloyd, and Kevin Keener, which is incorporated herein by reference, and improvements thereto disclosed below. The result is a fried food product with an equivalent sensory experience and measurable heath and economic benefits.

One illustrative embodiment of a CDR oven according to the present disclosure is configured to enable food service and food processing companies to evaluate and test CDR technology on food products. Those companies that are looking to take advantage of CDR technology and expand their food offerings to include healthier food choices to consumers desire CDR ovens for their own product development laboratories, including, for example, QSRs and food manufacturing firms.

An important aspect of illustrative embodiments of a CDR oven is the physical placement of the emitters and associated elements, for example reflectors, within the working chamber of the CDR oven. This includes the emitter location relative to the food product path through the oven, the conveyance system, and adjacent emitter locations, or heating zones.

Another illustrative embodiment of a CDR oven according to the present disclosure provides mechanical adjustability and control (for example, position) and electrical adjustability and control (for example, power) of the emitters, including providing for emitter operation from zero percent heat to 100 percent heat to achieve various heat fluxes and heat profiles throughout each healing zone of the CDR oven.

An additional illustrative embodiment of a CDR oven according to the present disclosure includes a conveyance system providing one or more of: vertically oriented conveyance screens on each side of food portions to hold portions in place, food portions oriented in a vertical plane, individual food portion carriers, control of spacing of food portions, quick change between various food portion carrier types, a mechanism for linked equilateral adjustment of distance for emitter pairs, aspects that provide safety/sanitation/ease of cleaning, over/under conveyance, and rotary (side/side) conveyance.

Yet another illustrative embodiment of a CDR oven according the present disclosure includes an emitter array having one or more of: a plurality of IR emitters arranged to simulate an immersion fry profile along the a longitudinal axis and to apply a uniform radiation pattern along a plurality of vertically axes, each vertical axis associated with an emitter and intersecting the longitudinal axis; removable glass shielding; aspects that minimizes variations from convection, pre-heating, etc; and provides various orientations of emitters relative to food products.

Another illustrative embodiment of a CDR oven according the present disclosure includes a control system providing one or more of: separate conveyance of individual food portions of varying types and selecting and applying a radiant fry profile for each food portion based a the type of food portion, emitter replacement due indicator (based on watt/hour log, or power sensing), adjustment of power based on emitter use/age, single button selection to select required profile for food type, and entry of food type and dimensional information to calculate required profile.

An illustrative embodiment of a CDR oven according the present disclosure includes one or more of: infinite control and adjustment and sensing capabilities to support test kitchen food product and process development, conveyance along a substantially vertical axis (for example to minimize counter space in a convenience store or QSR), combined with refrigeration/freezer unit for food product, payment and dispensing system for vending of food product, hook conveyance for food products such as bagels, donuts, and the like, non-continuous oven (no conveyor) applying a radiant profile simulating immersion frying, and instant on features (minimal or no warm up of glass/reflectors/etc).

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a perspective assembly view of an illustrative embodiment of a CDR oven according to the present disclosure;

FIG. 2 is a perspective view of the conveyance system of the CDR oven of FIG. 1;

FIG. 3 is a perspective view from the cooked end of the CDR oven of FIG. 1 and illustrating the conveyance system and heating zones;

FIG. 4 is a perspective view of the CDR oven of FIG. 1 with the cover removed to illustrate the heating zones along the radiant frying path;

FIG. 5 is a partial perspective review of the CDR oven of FIG. 1 illustrating a portion of the emitters along one side of the radiant frying path;

FIG. 6 is a perspective view showing the various components of a single emitter of the CDR oven of FIG. 1; and

FIG. 7 is a perspective view of the cooked end of the CDR oven of FIG. 1 illustrating the conveyance system and the mechanism for mechanical adjustment of the transmission distance of the emitters.

### DESCRIPTION OF THE ILLUSTRATIVE EMBODIMENTS

For the purposes of promoting and understanding the principals of the invention, reference will now be made to one or more illustrative embodiments illustrated in the drawings and specific language will be used to describe the same.

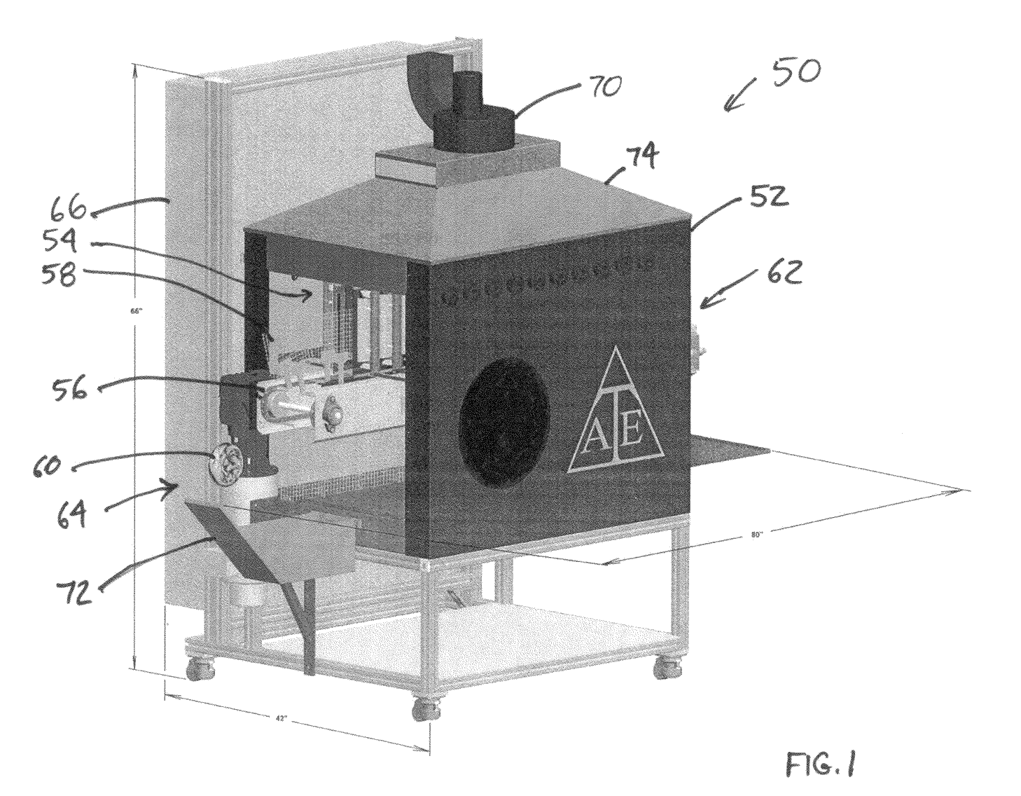

Referring to FIG. 1, a first illustrative embodiment of a continuous CDR oven 50 generally includes an enclosure 52, a plurality of radiant heating zones 54, a conveyance system 56, and a control system 66. The conveyance system 56 includes a plurality of food carriers 58 for receiving food portions 60 at a intake end 62 and transporting the food product through the plurality of heating zones 54 to a cooked end 64. The enclosure 52 may include an exhaust fan 70, a cooked food drop bin 72, and a cover 74. Materials used to construct various components of the illustrative CDR oven 50 are those typically used for food processing equipment where appropriate, for example, stainless steel and/or other durable sanitary materials.

Conveyance System

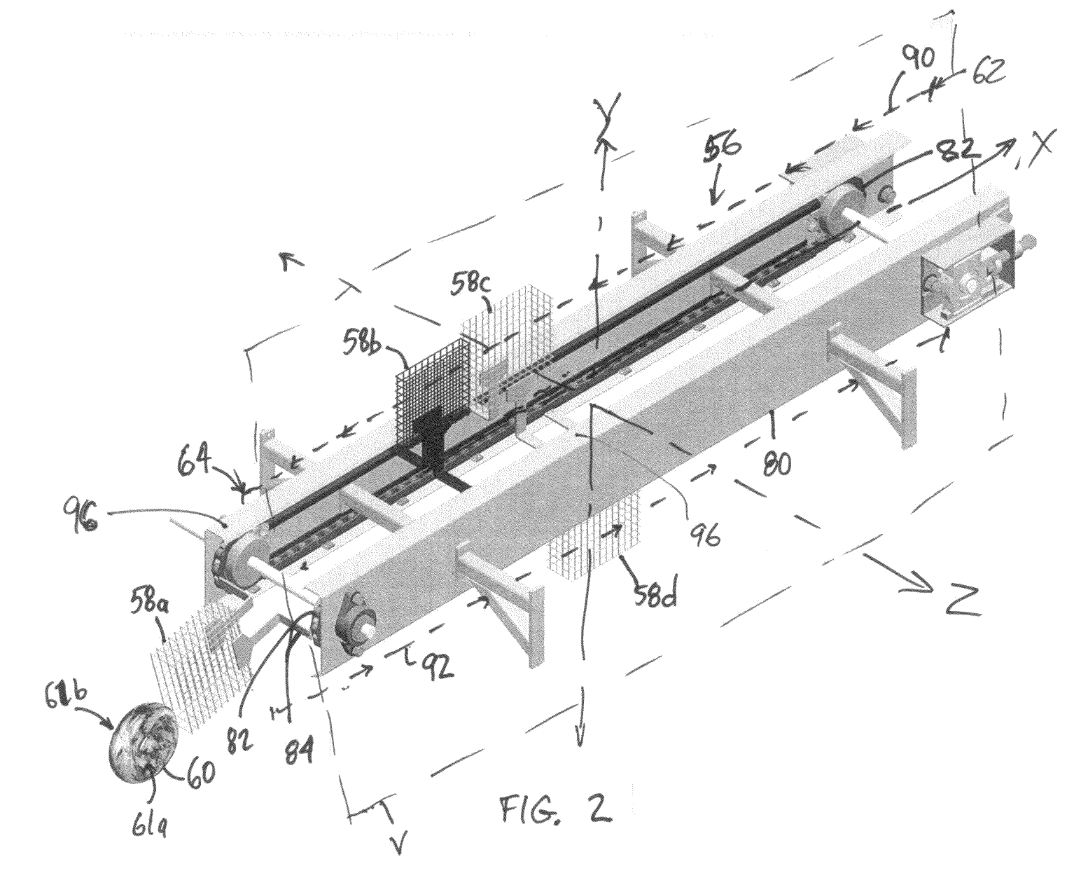

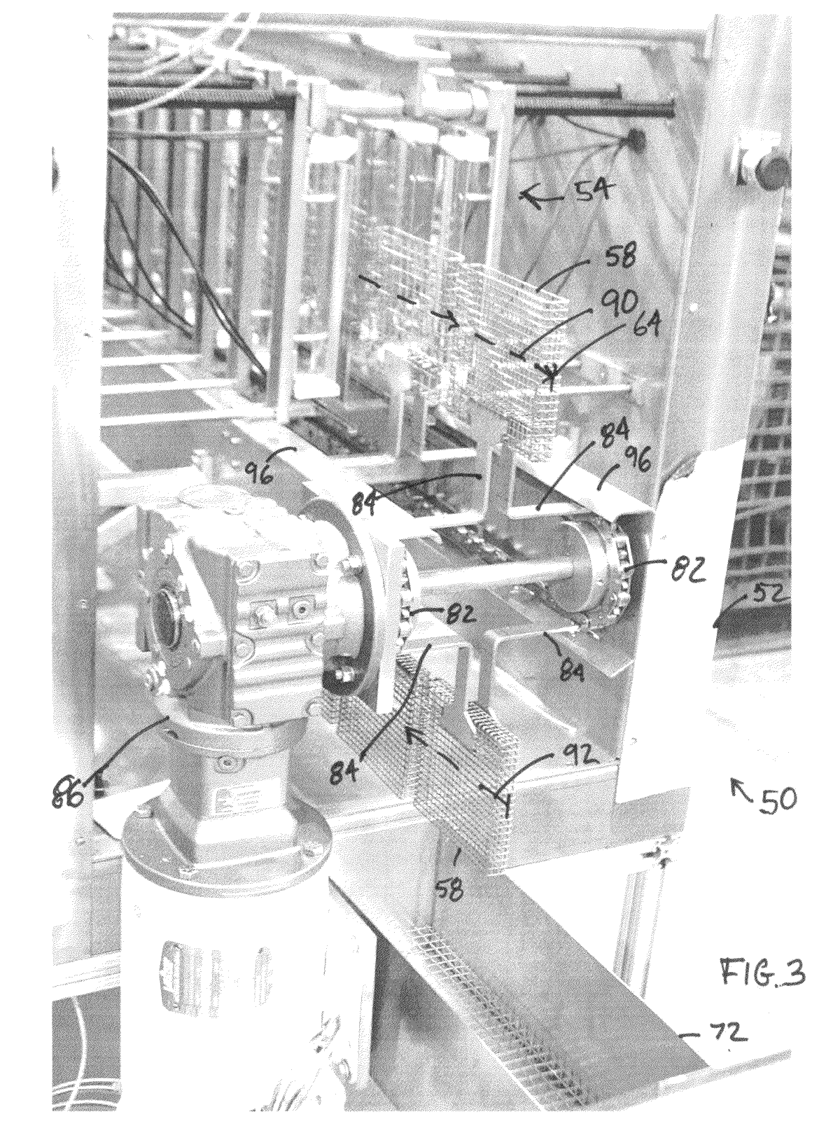

FIGS. 2 and 3 show an illustrative conveyance system 56 of the CDR oven 50. The conveyance system 56 includes a support structure 80, conveyors 82, a plurality of food carriers 58, carrier supports 84 coupling each food carrier 58 to the conveyors 82, and a drive unit 86 (FIG. 3). The conveyance system 56 provides transport of the food portion 60 along a radiant frying path (chamber) 90 (FIG. 2) from initial end 62 to the cooked end 64. In the illustrative conveyance system 56, the radiant frying path 90 is parallel to a horizontal axis X (FIG. 2) and food carriers 58 along the radiant frying path 90 are oriented to hold the food portions 60 in a vertical plane V defined along the length of the radiant frying path 90 and by vertical axis Y. Specifically, the opposite side 61a and 61b having the largest surface areas of the food portion 60 are oriented parallel to the plane V by the food carrier 58.

In addition to orienting the food portion 60, the food carriers 58 also provides control of spacing of the food portion 60 along the radiant frying path 90. Advantageously, the food product carriers 58 associated with the conveyance system 56 may include variations in food carrier designs for example thickness and screen variations of food carrier 58b versus food carrier 58c to enable the conveyance system 56 to transport more than one type of food portion 60. Optionally, the carrier supports 84 coupling each food carrier 58 to the conveyors 82 may be adapted so that one or more food carriers 58 may be easily coupled and uncoupled from the conveyors 82, thereby facilitating change from one type of food carrier design to another. Alternatively, the food carriers 58 may be a disposable component, for example packaging for food portion 60, that is releasable coupled to the conveyors 82 for a single or very few uses.

The food product carriers 58 and/or supports 84 and conveyors 82 also may provide for adjustment of components of the food carriers 58 to accommodate variations in the food portion 60. For example, a food carrier 58 may include opposite screens, with an adjustable distance therebetween, enabling the screens to close in against opposite sides of the food portion 60, thereby retaining the food portion 60 for transport along the radiant frying path 90.

Because radiant frying of the food portion 60 occurs along the path 90, with the exception of the empty food carriers 58 translating along a return path 92, the space below the food carriers 58 along the radiant frying path 90 is advantageously free of critical components that may be subject to dripping oil and falling food debris. Additionally, the conveyors 82, for example a sprocket and chain system, is offset laterally from below the radiant frying path 90. Furthermore, shields 96 further protect the conveyors 82 from accumulating oil and food debris. Although an over and under conveyance system is shown, other arrangements may be utilized, for example, a lateral or vertical side-by-side arrangement, or a lateral rotary arrangement. Additionally, although in the illustrative CDR oven 50 radiant frying occurs only along the radiant frying path 90 and not the return path 92, other embodiments may include radiant frying along substantially the entire path of the conveyors 82, with only a non-heating zone for insertion and removal of the food portion 60.

Radiant Emitter Array

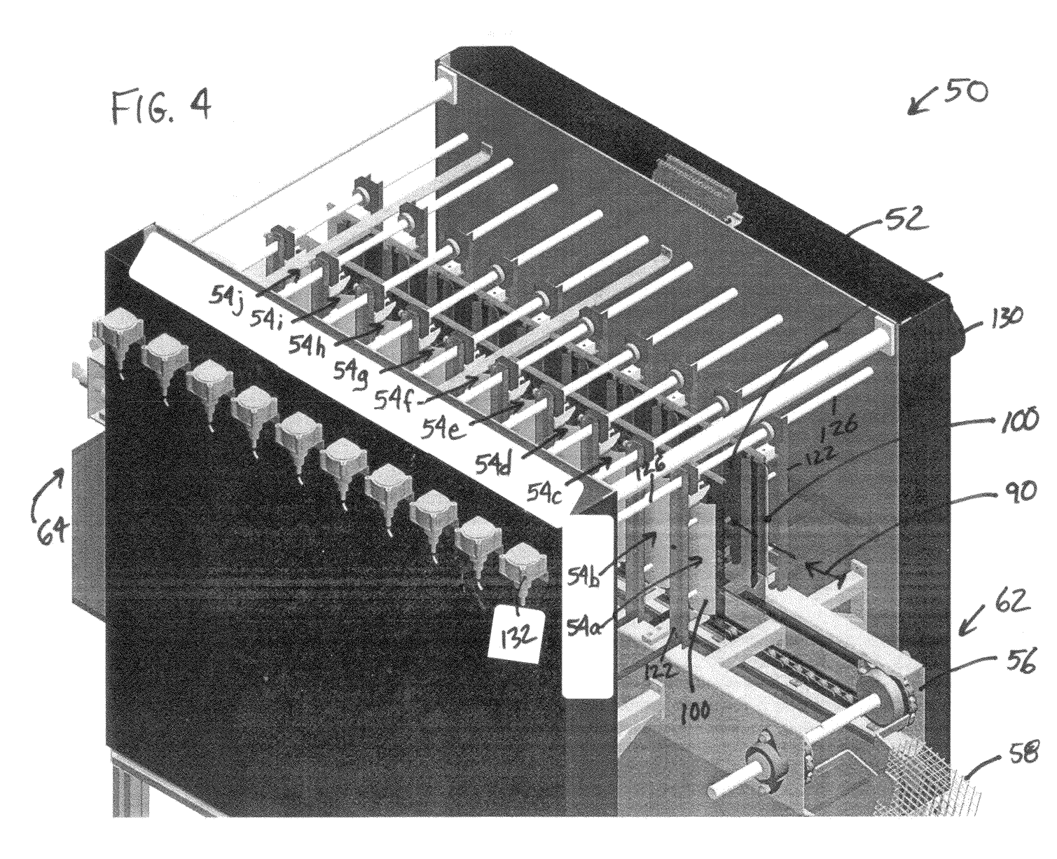

Referring to FIG. 4, the illustrative continuous CDR oven 50 includes a plurality of heating zones 54a-54j (collectively 54) along the length of the radiant frying path 90. Food products that are fried by immersing in oil are exposed to a heat flux (W/m²) that varies significantly over time. For example, an initial high heat flux is delivered upon immersion, for example about 20-30,000 W/m², producing a crust matrix on the exterior of the food. Then a lower heat flux heats the interior of the food, for example, the heat flux decreases at a rapid to less than about 10-15,000 W/m², and then decreasing more slowly to less than about 5,000 W/m². To mimic such a heat profile in a continuous oven, the heating zones 54 are each configured to provide a predetermined heat flux to the food portion 60 thereby providing a variable heat flux along the length of the radiant frying path 90 that results in the food portion 60 being exposed to the desired heating profile.

To achieve the variations in the heat flux among the heating zones 54 in the illustrative continuous CDR oven 50, the heat flux delivered in a particular heating zone 54 is adjustable, thereby providing an infinite number of possible heating profiles along the radiant frying path 90. Additionally, sensing of the heat flux provided in one or more of the heating zones 54 can also be provided. In other embodiments of a CDR oven according to the present disclosure, for example a CDR oven designed for a particular type of food portion 60, one or more or all of the heating zones 54 may each be configured to provide a fixed pre-determined heat flux to the food portion 60, thus also providing a single desired heating profile along the radiant frying path 90.

In the illustrative CDR oven 50, the width of each heating zone 54 is about 3-4 inches; however, other widths may be selected depending on the transit speed and heating profile desired for the type of food product. As shown in FIG. 4, each heating zone 54 includes a pair of radiant emitters 100. For example, in heating zone 54a, each emitter 100 heats one side of the food portion 60. In other embodiments of the CDR oven for food products for which only one side is heated, or only one side is heated at a time, a single radiant emitter 100 may be included in each heating zone 54.

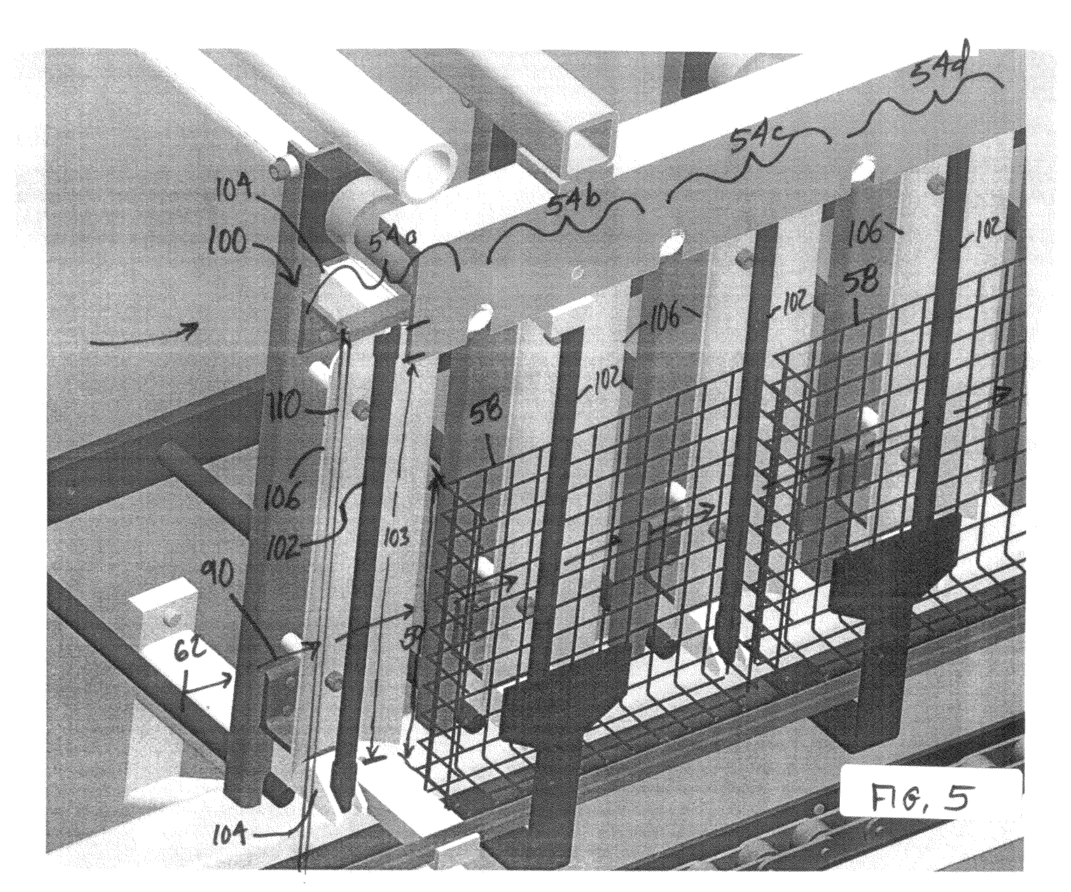

Referring to FIG. 5, each emitter 100 includes one or more emitter elements 102. In the illustrative embodiment, the emitter 100 includes a single IR emitter element 102, for example, a quartz halogen bulb. The emitter 100 also includes emitter element supports 104 and a reflector 106 located on the side of emitter elements 102 opposite the radiant frying path 90. A set of like emitter elements 102 for the heating zones 54 can be used that provide varying performance characteristics based upon control adjustments, or different emitters 102 can be used for the heating zones 54 along the radiant frying path 90 to achieve the desired variable performance.

Additionally, to protect the emitters 100 from oil splatter and food debris from the food portion 60, a splatter screen 110 can be positioned along of the radiant frying path 90, specifically, between the emitters 100 and the radiant frying path 90 on each side. For example, the splatter screen 110 may be a piece of glass that is resistant to breaking from heat and that has a high IR transmissivity. Additionally, the screen 110 can be removable, for example slideably removed, for convenience in cleaning.

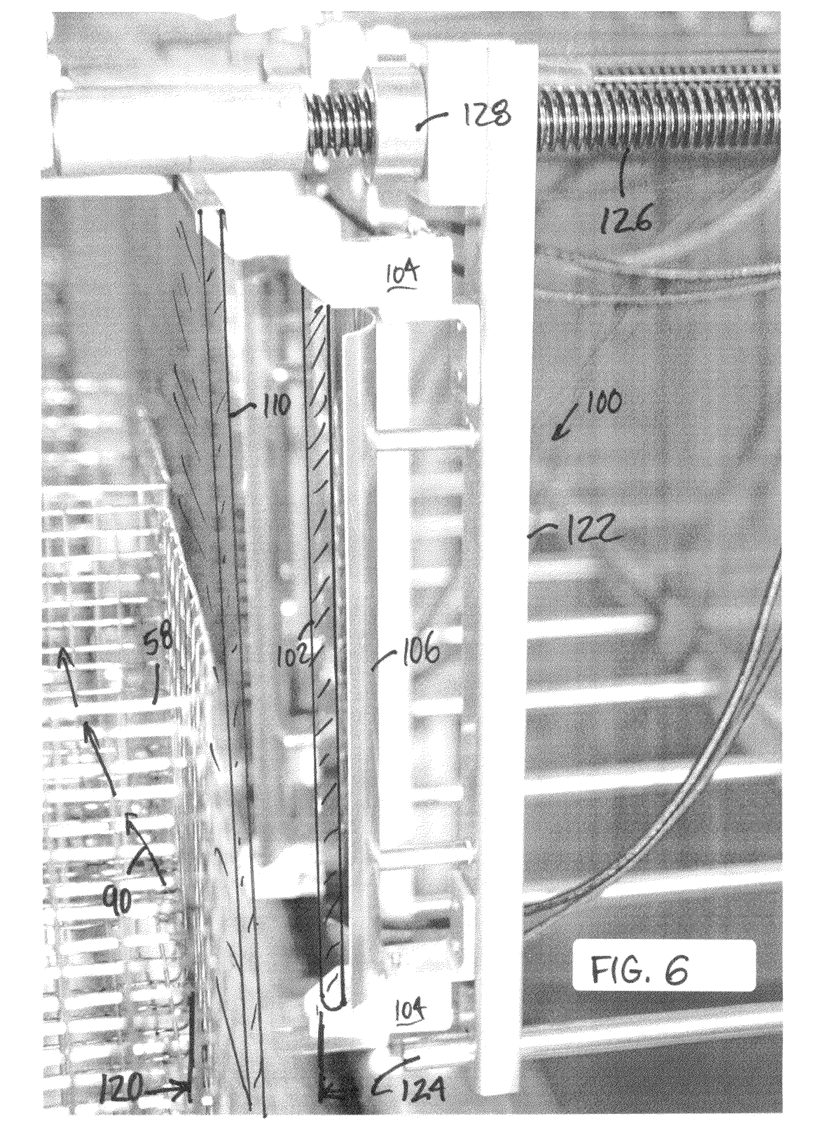

One method of adjusting the heat flux applied to the food portion 60 is by adjusting the transmission distance 120 (FIG. 6) between the food portion 60 and the emitter element 102 (along the transverse axis Z, perpendicular to the plane V shown in FIG. 2). Depending on the type of emitter element 102 used, the transmission distance 120 is generally less than several inches, and typically less than a few inches.

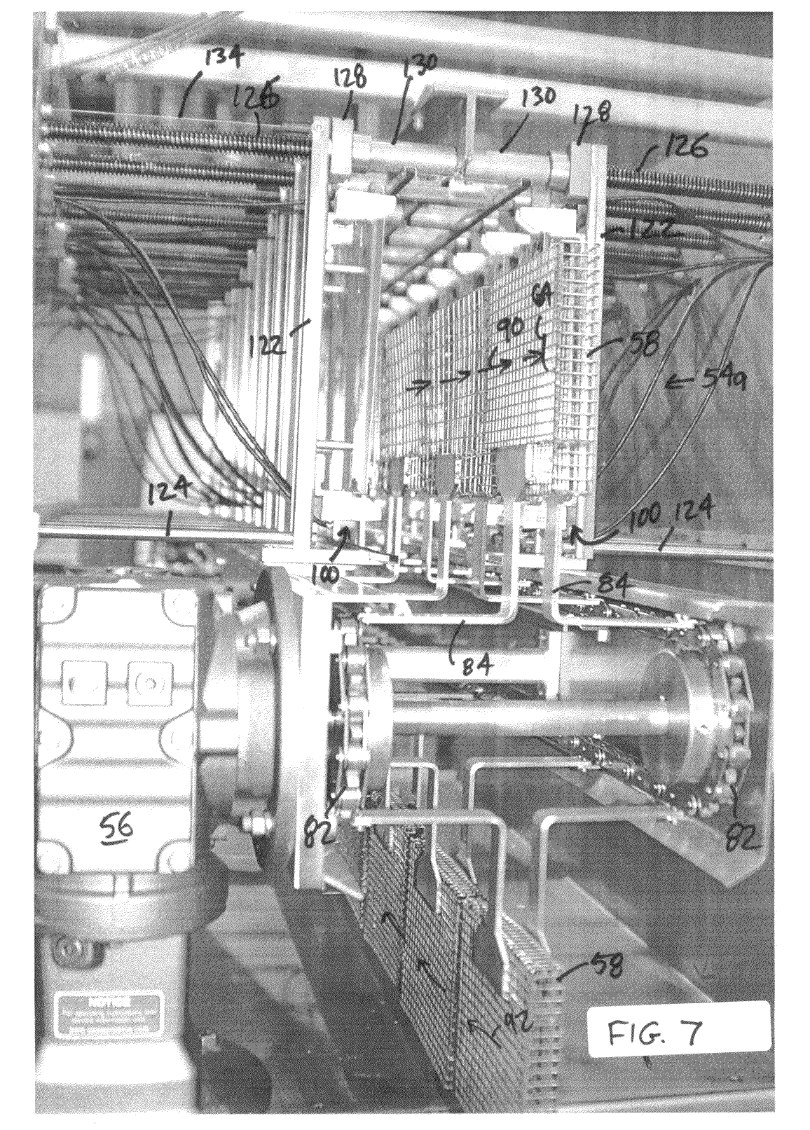

To facilitate this mechanical adjustment of the heat flux, the emitters 100 include a carriage 122 that translates along a rod 124 and a threaded rod 126 by way of a roller-thread (or roller-screw) mechanism 128 coupled to the carriage 122 translating linearly upon rotation of the threaded rod 126. Referring to FIG. 7, advantageously, interior ends of threaded rods 126 include couplers 130 that are joined so that the threaded rod 126 for each pair of emitters 100 rotate simultaneously, and the associated roller-thread mechanisms 128 cause the carriages 122 to translate equally and opposite directions, thereby maintaining an equal transmission distance 120 along transverse axis Z on opposite sides of the food portion 60.

Referring to FIGS. 4 and 7, a manual or electromechanical drive 130 can be used to selectively rotate each pair of threaded rods 126. Additionally, a sensor such as a cable-extension transducer 132 having a cable 134 coupled to one of the carriages 122 for each pair of emitters 100 can be used to provide measurement and control of the transmission distance 120.

Referring to FIG. 5, in each heating zone 54 it is generally desirable to provide a substantially uniform radiation pattern along the vertical axis Y (FIG. 2) to radiate the full height 59 of food portion 60 supported by the food carriers 58. For example, in the illustrative embodiment of CDR oven 50, the emitter elements 102 radiate IR energy along a length 103 that exceeds the food carrier height 59. For example, for a number of prepared food products, an emitter element 102 approximately 8 inches long is sufficient. Although the emitter element 102 is oriented along the vertical axis Y. in the illustrative embodiment, other orientations may be utilized, for example to provide different heating effects to different portions of the food portion 60. Additionally, for food products 60 having curvilinear sides 61a and/or 61b, curvilinear emitter elements 102 may be used to provide equal or non-equal heat flux, as desired, across the food portion 60. For example, suitable emitter elements 102 include wire, ribbon, and lamp type IR elements, and other radiant elements, for example, suitable for providing an equal heat flux cross food portion 60 of sufficient intensity to produce a crust matrix in a length of time similar to that of oil immersion frying.

Referring to FIG. 4, in contrast to emitters 100 and the food portion 60 being stacked vertically such that heat rises from lower emitter to the food portion 60 and to an upper emitter, it can be appreciated that the heating effects of convection are minimized with the relative positions and orientation of the food carriers 58 and the emitters 100 in the illustrative CDR oven 50.

Control System

The illustrative continuous CDR oven 50 includes a control system 66 for controlling and monitoring the conveyance system 56, the plurality of heating zones 54, and the radiant frying of food products 60. More specifically, the control system 66 includes a processor, software, and an HMI, for example including a display and input device. The control system 66 may also include additional control and sensing components, for example, motor control devices for drive 86 to control the position and motion of the food carriers 58, relays and/or SCRs to control power supplied to emitters 100 for each heating zone 54, and current monitors to determine the power of each emitter 100. A combination some or all of the above control system features thus provides storage and application of unique heat profiles required for each type of food product.

The separate conveyance of individual food portions of varying types in separate food carriers 58 enables the control system 66 to be used to select and apply a specific radiant heating profile for each food portion 60, for example, based on the type of food portion 60 held by a specific food carrier 58. For example, upon insertion of a food portion 60 in a food carrier 58 position at the intake end 62 of the CDR oven 50, an operator may select via an HMI, or the control system 66 may otherwise determine based on sensors known in the art, the type of food portion 60. For example, an on-screen or electromechanical selection switch for each available food type and/or heating profile can be included with the HMI.

By the selection identified, the control system 66 can apply a heating profile, for example, by controlling one or more of the speed of the conveyors 82 and the heat flux applied by each heating zone 54 to the food portion 60 in order to provide a predetermined heating profile pre-associated with the type of food portion 60. Identification of the type of food portion 60 may also include composition, temperature, and dimensional information in order to calculate a required heating profile to radiant fry the food portion. Additionally, the selection via the HMI may also include a desired degree of frying used to further determine the heating profile to apply to the food portion 60.

The control system 66 can also provide an indication of when replacement of particular emitter elements 102 are due, for example, based on a watt/hour log for each heating zone 54 to determine accumulated use versus planned replacement, or based on power sensing to determine performance decline. In order to provide constant heat flux over the life of emitter elements 102, the control system 66 can also adjust power based on emitter use/age and expected decline in performance for the accumulated use/age.

### Application Specific Designs

Although the above discussed features of the illustrative continuous CDR oven are generally suitable for a test kitchen oven, these and other features can be selectively included or excluded in order to provide a CDR oven suitable for other applications, including for example, for food manufacturing facilities, QSRs, industrial kitchens, convenience stores, food vending, residential kitchens, and other environments.

For example, an illustrative embodiment of a CDR oven for only one or a couple of food product types may include a first heating zone having an emitter elements 102 selected to optimize formation of a crust matrix, for example delivering higher heat flux and/or wavelengths that less penetrate the food portion 60 than those for interior food heating. Additionally, the transmission distance 120 and/or speed of conveyors 82 may be fixed to what is optimal for that type of food product.

Another illustrative embodiment of a CDR oven that minimizes footprint, for example to minimize counter space in convenience store, may include a radiant frying path oriented such that it has a vertical component or is substantially parallel to vertical axis V. Yet another illustrative embodiment of a CDR oven, for example for food vending, may be combined with refrigeration or freezer unit for storing food portions 60 until frying is desired, and may also be combined with a payment and dispensing system for vending of food portion 60.

An additional illustrative embodiment of a CDR oven includes an alternative food carrier 58, for example, an arrangement suitable for positioning and conveying the particular type(s) of desired food product(s), for example, a hook for conveyance of bagels, donuts, and the like along the radiant frying path 90.

Yet another illustrative embodiment of a CDR oven is non-continuous, for example, without a conveyance system 56, and having a single heat zone/chamber using one or more emitters 100 that are adjustable electrically and/or mechanically as discussed above to provide a varying heat flux following a radiant heating profile simulating immersion frying. Alternatively, the single heat zone can include a first emitter set selected to provide a crust matrix and a second emitter set selected to provide interior heating, for example, the first emitter set activated for a first period of time and the second emitter set activated for a second period of time.

Test Kitchen Application

A spectroradiometric measurement system can be used, for example in conjunction with control system 66, to measure incident heat flux as a function of position and power settings for the emitters 100. This provides heal flux profiles that are generated for various control settings.

A pyrofiber flux sensor can be connected to a data logger portion of the control system 66 and mounted on one or more of the food portion carriers 58 of the CDR oven 50. Individual emitters can be turned on and off independently allowing a measurement of incident flux from each emitter 100. For each emitter 100, controlling incoming current will generate a range of temperatures. Temperature of emitters are measured using a fiber optic temperature probe. Average emitter temperature can be calculated based on Stefan Boltzmann Law of Spectral Emission and assuming the emission source as a black body, thus further determining the heat flux profiles of the CDR oven 50 for various settings.

Once the available heat flux profiles that result from particular emitter selections, positions, power settings and other associated variables are know, then the CDR oven 50 and associated control system 66 can be specified that provides a heat flux profile mimicking that of immersion frying for a particular food product 60. Mimicking the heat flux profile for immersion fried food products provides desired attributes such as appearance, flavor, texture, crispness intensity, oily mouth-feel, and moisture content. Additionally, the variable nature of the illustrative CDR oven 50 allows for further testing to determine how changes in the variables (and thus heat flux profile) change the various food product attributes in a desirable or undesirable fashion. While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the following claims are desired to be protected.

1. A continuous oven for radiant frying of food portions, comprising:
a plurality of heating zones each having at least one elongate infrared emitter extending along an axis having at least a vertical component; and
a conveyance adapted for orienting food portions vertically.

2. The oven of claim 1, wherein the conveyance includes pairs of screens for holding the food portions vertically.

3. The oven of claim 1, wherein the conveyance includes a plurality of individual food portion baskets.

4. The oven of claim 3, wherein the plurality of individual food portion baskets are releasably coupled to the conveyance system, the plurality of individual food portion baskets including a baskets supporting a plurality of food portion sizes.

5. The oven of claim 3, wherein disposable food packaging defines at least a portion of each of the plurality of individual food portion baskets.

6. The oven of claim 1, wherein the conveyance includes an over and under path that translates through a vertical plane.

7. The oven of claim 1, wherein the conveyance includes a rotary path that translates through a horizontal plane.

8. The oven of claim 1, wherein comprising a plurality of members that provide specific spacing of food portions along the conveyance.

9. The oven of claim 1, where each of the plurality of heating zones includes an infrared emitter located on each opposite side of the food portion conveyance, and the oven further comprising:
a movable carriage for each of the elongate infrared emitters; and
an adjustment mechanism linking the oppositely located movable carriage for each heating zone so that adjustment of the distance of the infrared emitter to the food portion on one side equally adjusts the distance of the infrared emitter to the food portion on the other side.

10. The oven of claim 1, further comprising at least one removable glass shield between the infrared emitters and the food portions.

11. The oven of claim 1, wherein the infrared emitters are arranged to simulate an immersion fry profile along the a longitudinal axis and to apply a uniform radiation pattern along a plurality of vertically axes, each vertical axis associated with an emitter and intersecting the longitudinal axis.

12. The oven of claim 1, wherein the conveyance includes at least one hook for hanging a food portion.

13. An oven for radiant frying of food portions, comprising:
a plurality of heating zones each having at least one infrared emitter;
a conveyance adapted for carrying food portions through the plurality of heating zones; and
a control system capable of controlling the plurality of heating zones and conveyance to apply a radiant fry profile to each food portion.

14. The oven of claim 13, wherein the conveyance provides separate conveyance of each food portion and the control system applies a radiant frying profile to each food portion appropriate to the type of food portion.

15. The oven of claim 13, wherein the control system indicates infrared emitter replacement due based on one of usage history and power sensing.

16. The oven of claim 13, wherein the control system adjusts power supplied to the infrared emitters based on usage history to provide a level output over the life of the emitter.

17. The oven of claim 13, wherein the control system further comprises a plurality of selections each associated with a particular type of food portion and the appropriate radiant frying profile.

18. The oven of claim 13, wherein the path of the food portion conveyance is oriented along a substantially vertical path.

19. The oven of claim 13, further comprising a cold section for storing the food portions prior to radiant frying.

20. The oven of claim 13, wherein the control system includes a payment system.
